(19) United States
(12) Patent Application Publication
(10) Pub. No.: US 2010/0184616 A1
(43) Pub. Date: Jul. 22, 2010

(54) SPATIALLY CONTROLLED ILLUMINATION OF BIOLOGICAL SAMPLE ARRAY THROUGH WEDGE-SHAPED SUPPORT

(75) Inventors: James Hillendahl, Vacaville, CA (US); David Waldbeser, Martinez, CA (US); Saul Saucedo, Stockton, CA (US); Timothy Andrews, Richmond, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BIO-RAD LABORATORIES, INC., Hercules, CA (US)

(21) Appl. No.: 12/686,832

(22) Filed: Jan. 13, 2010

Related U.S. Application Data
(60) Provisional application No. 61/145,792, filed on Jan. 20, 2009.

(51) Int. Cl. C40B 30/04; C40B 60/12

(52) U.S. Cl. 506/9; 506/39

(57) ABSTRACT

Two-dimensional samples or sample arrays such as electrophoresis gels and microplates, containing fluorescently labeled species, are illuminated by an illumination device that includes a slab of non-autofluorescing or low-autofluorescing material shaped to receive excitation light from one or more edges and to distribute the light to emerge from an upper surface of the slab at a uniform intensity along the length and width of the upper surface.

### CROSS REFERENCE TO RELATED APPLICATION

This application claims the benefit of U.S. Provisional Patent Application No. 61/145,792, filed Jan. 20, 2009, the contents of which are incorporated herein by reference.

### BACKGROUND OF THE INVENTION

1. Field of the Invention

This invention lies in the field of methods and devices for the imaging of arrays of biological samples.

2. Description of the Prior Art

Fluorescent labels are widely used in biological and biochemical studies and analyses, and particularly in two-dimensional imaging of analytical media. Quantum dots, fluorescent dyes, and proteins or other biological species that fluoresce intrinsically have all been used as fluorescent labels. Media in which these labels have been used include rectangular arrays of discrete points on slides, chips, and microliter-sized samples in microplates, as well as continuous media such as tissue samples, colony counting plates, and slab-shaped electrophoresis gels. Detection and imaging with fluorescent labels in any of these media is achieved by illumination of the medium at an excitation wavelength appropriate to the label and detection of the emissions from the label that result from the excitation. To obtain accurate results, the illumination be uniform across the full length and width of the medium so that the points at each set of coordinates in the medium will receive the same illumination regardless of their locations. It is also important that the emissions be properly correlated with their points of origination and readily distinguishable from radiation or emissions not originating from the labels, and that the emission signals be quantifiable and, in many cases, recordable.

### SUMMARY OF THE INVENTION

The present invention resides in a transillumination system for fluorescence detection of a two-dimensional field with substantially uniform illumination across the length and width of the field. The invention achieves this by use of a slab of optically transparent material with a planar surface to support the labeled sample(s) and a wedge-shaped profile, illuminated by a light source trained on the edge of the slab at the thick end of the wedge. The transmission of light energy from the illuminated edge to the planar surface is achieved by reflection, refraction, or other light-redirecting means at the sloping lower surface of the slab. Optional additional features, such as localized reflective or refractive features on the lower surface of the slab or the use of a light source of non-uniform intensity along the length of the illuminated edge, contribute to the control of the distribution of light reaching the upper surface. Further optional features of the invention include one or more optical filters or equivalent elements integrated with the slab to limit the entering light to a selected excitation wavelength or wavelength range. The planar upper surface of the slab allows it to serve as a platen, or generally a support, for a two-dimensional sample or sample array, and the slab is preferably designed for insertion in an imaging instrument, particularly one that has only limited clearance below the array. In preferred embodiments, the slab is incorporated in a tray that includes the light source and any lenses, optical filters, and other components for light transmission and distribution in addition to electrical contacts for connection to a power source in the imaging instrument. The term “slab” is used here for convenience; it will be recognized from the description that follows that the component to which the term is applied is one that is highly engineered and used in a precision instrument.

These and other features of the invention and the means by which they are achieved are described below.

### BRIEF DESCRIPTION OF THE DRAWINGS

FIG. 1a is a side view of a slab in accordance with the present invention. FIG. 1b is a top view of the slab of FIG. 1a.

FIG. 2a is a cross section of a second slab in accordance with the present invention. FIG. 2b is a bottom view of the slab of FIG. 2a.

FIG. 3 is a cross section of a third slab in accordance with the present invention.

FIG. 4 is a cross section of a fourth slab in accordance with the present invention.

FIG. 5 is a perspective view of a fifth slab in accordance with the present invention.

FIG. 6 is a front view of a light source for use with the slab of FIG. 5.

FIG. 7 is a perspective view of a tray incorporating the slab of FIG. 1.

FIG. 8 is a perspective view of an imaging instrument designed to receive the tray of FIG. 7.

### DETAILED DESCRIPTION OF THE INVENTION AND PREFERRED EMBODIMENTS

The upper surface of a slab of the present invention is generally planar to allow the slab to serve as a sample support, and the lower surface of the slab is in most cases planar as well or has planar sections. A preferred slab geometry is one that is rectangular in shape and, in terms of thickness, a wedge, a truncated wedge, or a series of contiguous truncated wedges. In a wedge-shaped slab or a slab with wedge-shaped sections, the light source is trained on or optically coupled to the thick edge of each wedge. The term “optically coupled” is used herein to denote that all light emerging from one part, in this case the light source, is received by the other part, in this case, the thick edge of the wedge. The angle of the wedge is small enough that the surfaces, if perfectly smooth, would produce total internal reflection of most, and preferably all, of the entering light. The wedge can therefore be a few percent wedge, such as a 1% to 10%, and preferably a 2% to 8% wedge. (The expression “% wedge” is used herein for its conventional meaning, i.e., the distance of vertical rise over a given horizontal distance, divided by the horizontal distance, multiplied by 100.) The thick end of the wedge in preferred embodiments is about 4 mm to about 8 mm in thickness. The slab can be formed of a single wedge, or of two or more wedges each with their thick edges at the periphery of the slab facing outward and their narrow ends facing each other and joined. A rectangular slab can thus be formed of two to four wedges. With multiple wedges, each wedge will have an independent light source at its thick outer edge, and its own lens, filter, and other light distribution features, and each wedge will independently extract light along its length and width from the light entering at the edge and redirect the extracted light to the upper surface.

Surface features can be incorporated along the lower surface of the slab to assist in the extraction of light from the slab and the redirection of the light to the upper surface by means other than simple internal reflection. The surface features used in wedge-shaped light guides of the prior art, such as for example those used as back lights for liquid crystal displays (LCDs), can be used for this purpose. The distribution of these surface features in combination with the taper of the wedge can be selected to produce a substantially constant amount of light emerging from the upper surface of the slab per unit area of the upper surface. These surface features can be topographical features on the lower surface of the slab that are either reflective or diffractive. These topographical features can be a texture applied to the lower surface or digitally designed microstructured patterns including those with a holographic morphology. Examples of topographical features are spherical and elliptical indentations, and they can form either a regular or irregular array. Further examples of topographical features are frosting, microwedges, microprisms, and lines (either troughs or ridges) with light-redirecting profiles. The light-directing profiles can be round or those of microprisms. All such features are known in the art of light guides for LCDs. Topographical features can be formed by molding, machining, bead blasting, acid etching, or other chemical or mechanical means.

In addition to improving the transmission of light from the light source to the upper surface of the slab, the topographical features can be designed to compensate for inherent nonuniformities in light transmission through the slab. Longitudinal nonuniformities for example can arise from decreases in intensity due to absorption within the slab itself, since light rays traveling greater distances to reach the far end of the slab (opposite the light source) will suffer greater absorption before striking the lower surface than light rays that strike the lower surface closer to the light source. Likewise, nonuniformities in the lateral direction can arise from the escape of light energy through lateral, nonilluminated edges. Compensation for any of these nonuniformities can be achieved by using topographical features of varying size, height, spacing, and density along the direction of the nonuniformity. Topographical features that increase the extraction of light can be used at points of otherwise decreasing intensity and those that increase the absorption can be used at points of relatively high intensity. Similar variations can be achieved by the inclusion of localized absorptive or reflective areas, such as dots or grids, on the lower surface. Dots and grids can be applied in any conventional manner, such as painting or printing, and their sizes and densities can be varied in the same manner as the topographical features and toward the same purpose. An alternative to the topographical features, dots, and grids is a reflective or refractive film optically cemented to the lower surface of the slab. An example of such a film is one sold under the name VIKUITI™ TRAF2 (3M, St. Paul, Minn., USA).

The slab is made from a transparent material but preferably one of substantially no autofluorescence, i.e., low autofluorescence or no autofluorescence. The “substantially no autofluorescence” is used herein to denote that any autofluorescence is low enough to have no effect on an imager's ability to measure fluorescence intensities of the species to be detected relative to themselves and to other species in the sample. Materials known to be autofluorescing, such resinous (plastic) materials, are thus not favored. Various forms of glass, notably borosilicate float glasses, are preferred. One example is BOROFLOAT® 33 (Schott North America, Inc., Duryea, Pa., USA). Other suitable materials include fused silica and sapphire.

The light source can be any source that will illuminate an edge of the slab. When the slab is in the form of joined wedge sections, the sections will be arranged such that the thick edge of each wedge is at the outer edge of the slab, and a separate light source will illuminate each wedge at its thick end. Thus, when the slab is formed from two wedges meeting at their thin edges, a separate light source will illuminate each wedge, directing light toward the meeting line. A three-wedge slab will utilize three light sources, a four-wedge slab four light sources, etc. The wavelength range of the light source(s) can be selected to meet the needs of the fluorescent labels. Preferred light sources are those emitting in the ultraviolet, visible, or near-infrared ranges. A lens is included in preferred embodiments of the invention to collect, collimate, and direct the light from each light source into the slab, including light that might otherwise bypass the slab. While conventional light bulbs can be used as the light source, long bulbs and linelights are preferred when uniform intensities are sought along the length of the illuminated edge. Bulbs with reflectors to redirect light can also be used. Light emitting diodes (LEDs) can also be used, including those incorporating reflectors operating by total internal reflection, as can lasers. Arrays of LEDs or lasers can be used, as can a closely spaced array of bulbs or an LED linelight such as that available from StockerYale, Inc. (Salem, N.H., USA). An LED linelight is a continuous line of LED dies mounted directly on a printed circuit board with attendant optics including an aperture mask and a cylindrical lens.

A light source designed to compensate for losses of light at the lateral edges of the wedge can also be used, particularly for single-wedge or double-wedge slabs in which the lateral edges are exposed. Rows of individual, discretely spaced LEDs or lasers with closer spacing toward the ends of the rows can thus be used to achieve a higher intensity of supplied light at the ends.

When discrete, spaced LEDs or lasers are used, a lens that is either round or cylindrical and either spheric or aspheric can be used with each LED or laser. Such lenses are available from JML Optical industries Inc. and CVI Melles Griot (both of Rochester, N.Y., USA). A particularly preferred lens for its minimal space requirement is a Fresnel lens (Fresnel Optics, Rochester, N.Y., USA) in either a spherical or cylindrical format.

Where an optical filter is used, the filter is the last component that the light passes through before entering the slab. A preferred optical filter is a coated optical interference bandpass filter that transmits 70-95% of the light in a narrow wavelength range and blocks the light outside that range to the ppm level, preferably to optical density (OD) 6. Such a filter will prevent background light, including light leaking from the light source, from reaching the detector in the instrument in which the slab is inserted. The filter can be a long rectangular strip filter or a collection of small filters assembled into a long filter. For individual LEDs or lasers, small, round filters can also be used. When a Fresnel lens is included in the system, a filter will be useful in eliminating any autofluorescence produced by the Fresnel lens.

The brightness of the light emerging from the slab can be increased, and in many cases approximately doubled, by optically coupling a brightness enhancement filter (BEF) to the upper surface of the slab. Optical coupling is readily achieved with an optical cement or other conventional means. A BEF is a thin film that contains molded microprism features that use total internal reflection at high angles to retroreflect high-angle light rays back to the interior of the slab. Once in the slab, the reflected light continues to reflect off the microprisms until it approaches the microprisms at an angle of incidence that permits the light to emerge. This results in a smaller emission angle of the light relative to the direction normal to the bulk slab surface. When a BEF of molded plastic is used, autofluorescence can be minimized by using a very thin BEF. Alternatively, a BEF of microsheet glass can be used. An example of a BEF currently available is one sold under the product name VIKUITI™ BEF III (3M, St. Paul, Minn., USA).

The uniformity of the light emerging from the slab can be further enhanced by the placement of a diffuser at the upper surface of the slab. As in conventional diffusers used for general lighting, the diffuser can have a roughened, stippled, or frosted surface to diffuse light emerging from the slab before the light reaches the sample array. Any side of the slab can have a white or diffusive reflecting surface to improve uniformity.

The slab, light source(s), and lens(es), and filter(s) when included can be integrated into a tray that slides into an imager or other gel documentation system. Examples of imaging systems are the Bio-Rad Molecular Imager® Gel Doc™ XR System and Bio-Rad Molecular Imager® ChemiDoc™ XRS System, Bio-Rad Laboratories, Inc., Hercules, Calif., USA. The tray can contain electrical connections for coupling with a power source in the imager upon insertion of the tray. Alternatively, the tray can contain a battery pack as an integrated power supply.

As mentioned above, the illumination device of this invention can be used for imaging of biological samples in two-dimensional arrays as well as tissue sections, colony counting plates, and other two-dimensional samples. The device can also be used as an illuminator for performing calibrated densitometry on biological samples, such as nucleic acid gels stained with Coomassie Blue, using white light sources such as white LEDs or visible white light bulbs. The calibration itself can be performed with standard step-density tablet targets. Such targets are available, for example, from The Tiffen Company, Hauppage, N.Y., USA.

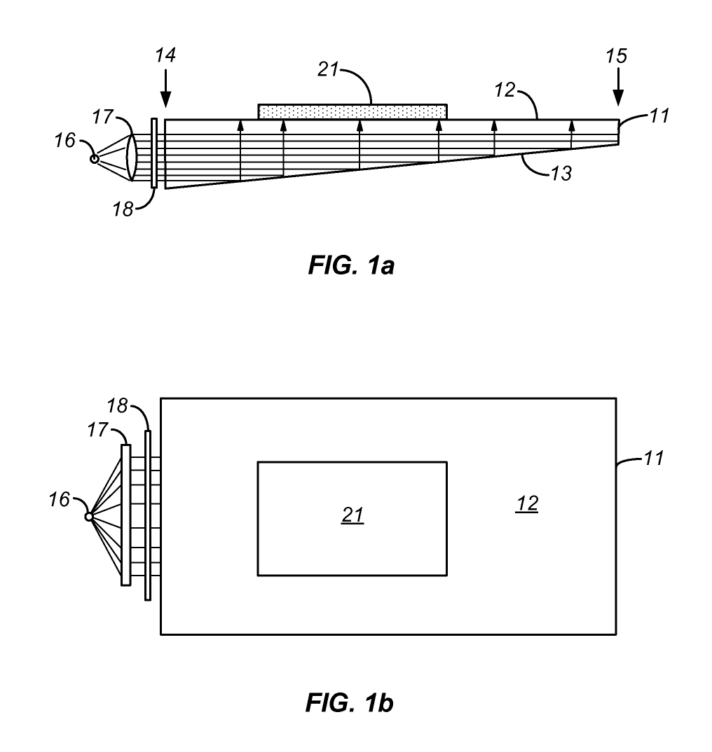

One example of a slab in accordance with this invention is shown in FIGS. 1a and 1b. The slab 11 in these Figures has upper and lower surfaces that are rectangular in shape, as indicated in the top view of FIG. 1b. As indicated in the side view of FIG. 1a, the upper surface 12 of the slab 11 is horizontal and planar while the lower surface 13 is planar but sloping, giving the slab a wedge shape, the slope of which is exaggerated in these figures. The thick edge 14 of the wedge is at the left in the view shown, and the thin edge 15 is at the right. The wedge is a truncated wedge in that it does not taper to a point but instead terminates in a finite thickness at the thin edge 15.

The slab of FIGS. 1a and 1b is a single wedge, and a single light source 16 is positioned to direct light to the thick edge of the wedge. A collimating lens 17 renders the rays from the light source parallel or approximately parallel, and an optical filter 18 filters out wavelengths that are outside the desired range. Extraction features molded into the lower surface 13 of the wedge control the redirection of the light rays from the interior of the slab upward to the upper surface 12 where the light rays emerge. An electrophoresis gel 21 is shown on the upper surface 12. Solutes or solute bands in the gel have been labeled with fluorescent dyes that receive excitation light from the light rays emerging through the upper surface 12. Detection of the fluorescence emissions is performed from above the gel.

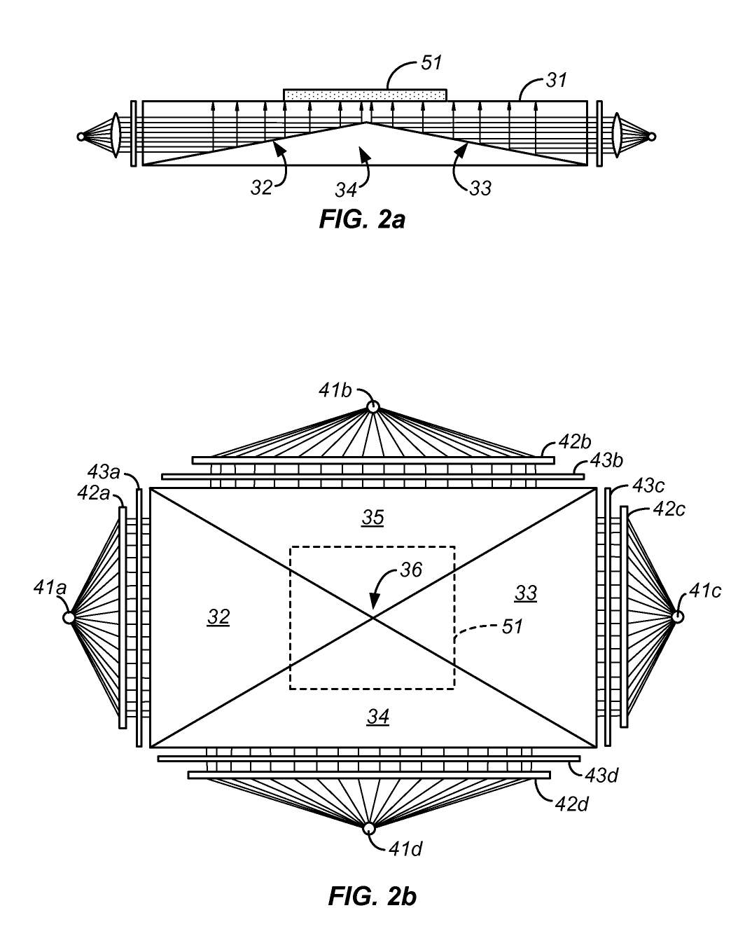

FIGS. 2a and 2b illustrate a slab 31 in the form of four wedges rather than one as in FIGS. 1a and 1b. In the cross section view of FIG. 2a, three of the wedges 32, 33, 34 are visible, while in the bottom view of FIG. 2b all four wedges 32, 33, 34, 35 are visible. The thick edges of the four wedges form the rectangular periphery of the slab 31, and each wedge is triangular in shape, with its lower surface angled upward toward the center of the slab. The slab thus has four facets at its lower surface, each facet defining the sloping surface of one of the four wedges. All four facets meet at the center point 36 of the slab, which is the thinnest point in the slab. Each of the four wedges has its own light source 41a, 41b, 41c, 41d, its own collimating lens 42a, 42b, 42c, 42d, and its own optical filter 43a, 43b, 43c, 43d. Each wedge operates in the same manner as the single wedge of FIGS. 1a and 1b, directing excitation light upward through the slab to emerge at the upper surface to be received by the electrophoresis gel 51 at the upper surface.

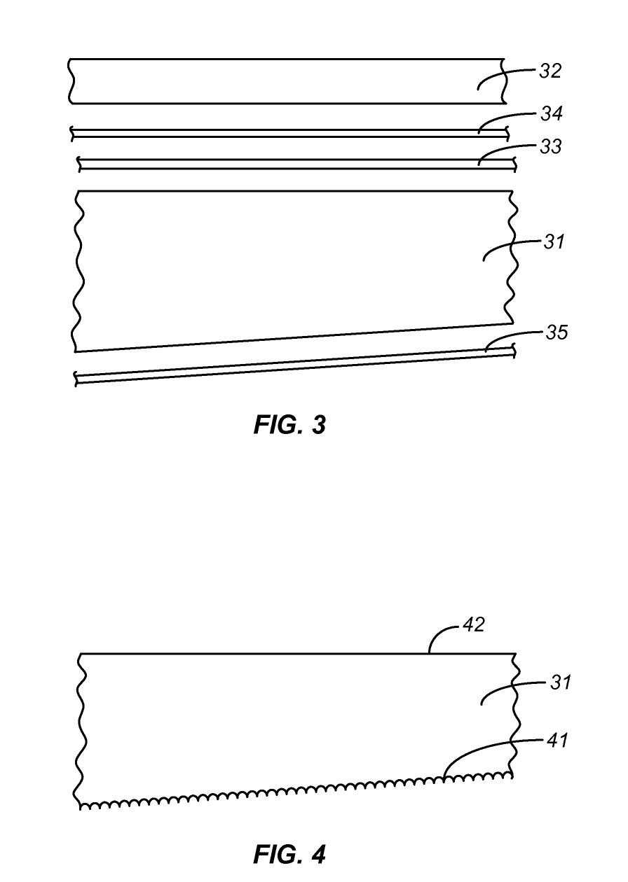

An exploded view of the various layers of a slab according to certain embodiments of the invention is shown in FIG. 3. The slab itself 31, and the sample, represented as an electrophoresis gel 32, are identical to those of FIGS. 1a and 1b. At the upper surface of the slab are a brightness enhancement filter 33 and a diffuser 34. At the lower surface is a film 35 enhancing the redirection of the light by either reflection or refraction.

Topographical features 41 on the lower surface of the slab 31 are illustrated in the side view of FIG. 4. As explained above, these features receive incident light from the light source and redirect the light to the upper surface 42 of the slab.

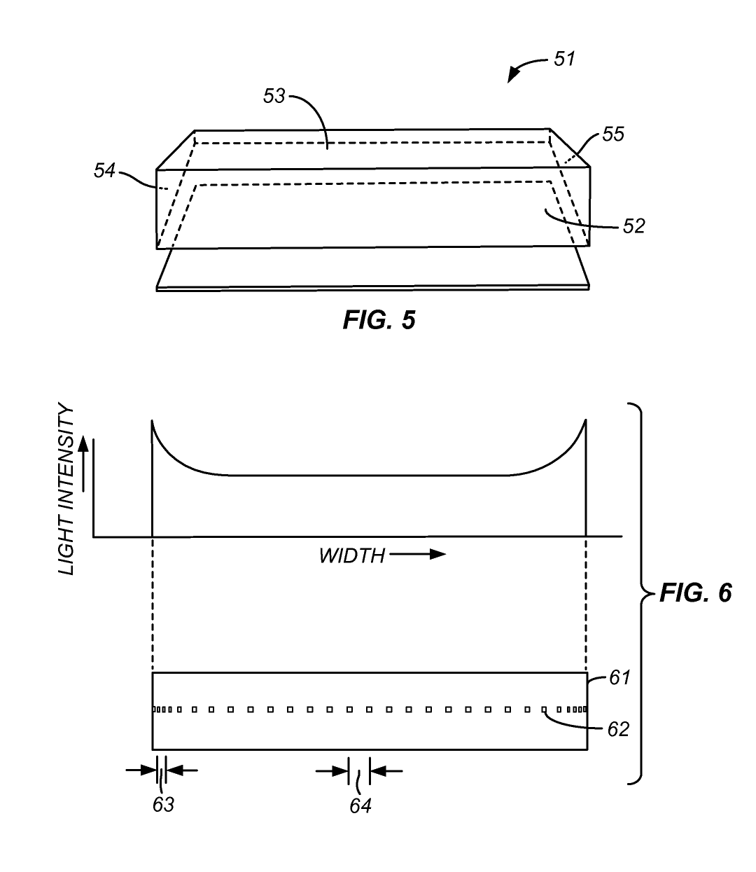

Lateral nonuniformity in the light emerging from the slab is illustrated in FIG. 5. The slab 51 in this Figure is shown in a perspective view from slightly above the thick edge 52 of the wedge. Light reaching the upper surface 53 from a light source trained on this thick edge 52 will undergo a drop-off in intensity at sites approaching the two lateral edges 54, 55. To compensate for this drop-off, the light source 61 shown in FIG. 6 is used. The light source 61 is a linear array of LEDs or lasers 62 whose center-to-center spacing 63 at the two ends of the array is smaller than the center-to-center spacing 64 in the center of the array. The resulting light output from the light source is shown graphically 65 where the vertical axis is light intensity.

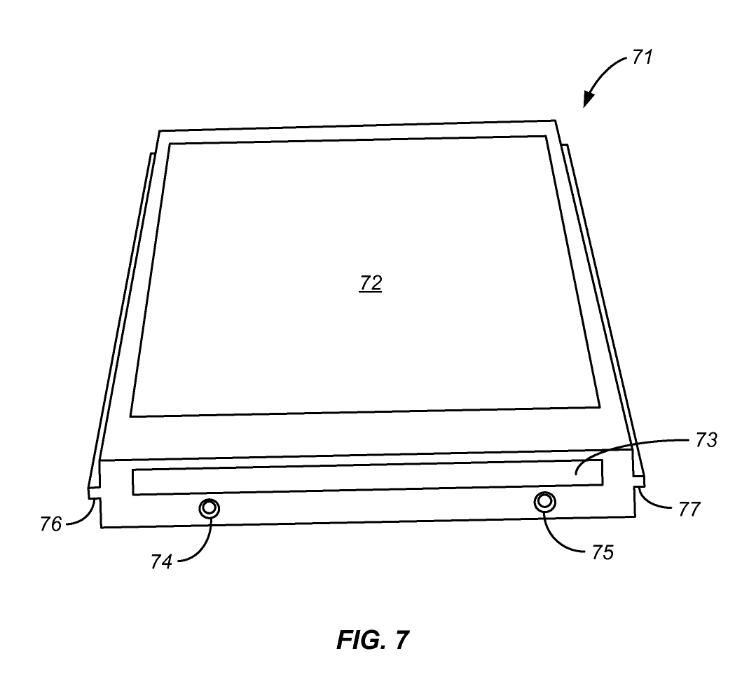

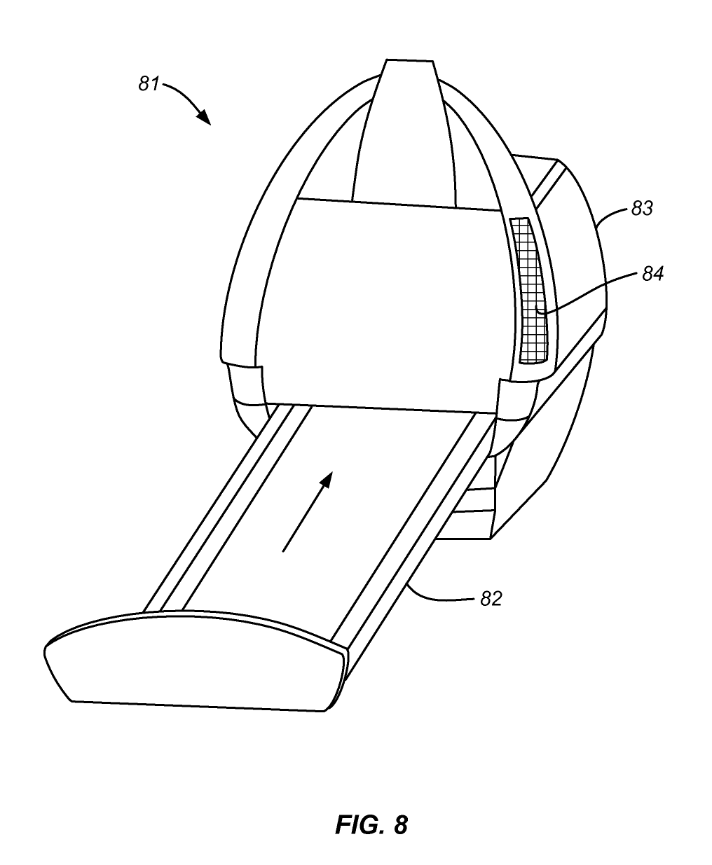

FIG. 7 depicts a tray 71 incorporating the components shown in the preceding figures, and FIG. 8 depicts an imaging instrument 81 to receive the tray and the sample. The parts visible in FIG. 7 are the upper surface 72 of the slab and an outer edge of the light source 73. Not visible but also incorporated in the structure are lenses, an optical filter, and the films or other layers optically coupled to the upper and lower surfaces of the slab. The tray 71 further includes electrical contacts 74, 75 to mate with corresponding contacts in the instrument 81, and guides 76, 77 for insertion of the tray in the instrument. As shown, the edge of the slab representing the thickest edge of the wedge is shown in the front of FIG. 7, and is designed to be inserted into the instrument with this end first. The instrument 81 in FIG. 8 includes a slide or drawer 82 on which the tray 71 is placed, and all detecting and imaging components are within the instrument housing 83 and not visible. A control panel 84 resides on the front of the instrument.

In the claims appended hereto, the terms “a” and “an” are each intended to mean “one or more.” The term “comprise” and variations thereof such as “comprises” and “comprising,” when preceding the recitation of a step or an element, are intended to mean that the addition of further steps or elements is optional and not excluded. All patents, patent applications, and other published reference materials cited in this specification are hereby incorporated herein by reference in their entirety. Any discrepancy between any reference material cited herein or any prior art in general and an explicit teaching of this specification is intended to be resolved in favor of the teaching in this specification. This includes any discrepancy between an art-understood definition of a word or phrase and a definition explicitly provided in this specification of the same word or phrase.

What is claimed is:

1. A device for illuminating a planar array of fluorescently labeled biological samples, said device comprising:
a slab of optically transparent material that displays substantially no autofluorescence upon irradiation with light, said slab comprising a section with a planar upper surface and a lower surface at an acute angle to said upper surface thereby providing said section with a generally wedge-shaped profile whose thickness increases to a maximum along one edge of said section, said lower surface directing light entering said section at said edge toward said upper surface;
a light source positioned to direct light into said section through said edge; and
an optical filter that selectively passes light within a preselected wavelength range, positioned between said light source and said edge.

2. The device of claim 1 wherein said slab contains exactly one said section.

3. The device of claim 1 wherein said slab contains more than one said section, and said device contains a separate said light source and a separate said optical filter for each said section.

4. The device of claim 1 wherein said slab contains two or four said sections, and said device contains a separate said light source and a separate said optical filter for each said section.

5. The device of claim 1 wherein said lower surface is planar.

6. The device of claim 1 wherein said wedge-shaped profile is within the range of a 1% wedge to a 10% wedge.

7. The device of claim 1 wherein said wedge-shaped profile is within the range of a 2% wedge to an 8% wedge.

8. The device of claim 1 wherein said lower surface is generally planar but with surface deviations distributed thereon to promote uniformity of light emerging from said slab through said upper surface.

9. The device of claim 1 further comprising regions on said lower surface with either greater absorptivity or greater reflectivity of light than the remainder of said lower surface, said regions distributed on said lower surface to promote uniformity of light emerging from said slab through said upper surface.

10. The device of claim 1 further comprising a collimating lens positioned between said light source and said edge and directing light from said light source through said edge that would otherwise bypass said edge.

11. The device of claim 1 wherein said light source is a continuous light source extending the full length of said edge.

12. The device of claim 1 wherein said light source is an array of discrete light sources arranged along said edge.

13. The device of claim 1 wherein said light source is an LED linelight.

14. The device of claim 1 wherein is an array of discrete light sources arranged along said edge to produce light of intensity that increases toward each end of said edge.

15. The device of claim 1 further comprising a brightness enhancement filter optically coupled to said upper surface.

16. The device of claim 1 further comprising a diffuser at said upper surface.

17. The device of claim 1 wherein said device further comprises a tray incorporating said slab, said light source, and said optical filter, and further containing features enabling said tray to be slid into an imager containing an incorporated power supply and electrical connections for coupling said light source with said power supply.

18. A method for illuminating a planar array of fluorescently labeled biological samples, said method comprising:
(a) placing said planar array on an upper surface of a slab of optically transparent material that displays substantially no autofluorescence upon irradiation with light, said slab having a lower surface at least a section of which is at an acute angle to said upper surface thereby providing said section with a generally wedge-shaped profile having a maximum thickness along an edge of said slab, said lower surface redirecting light entering said section at said edge and incident upon said lower surface toward said upper surface; and
(b) illuminating said slab with a light source positioned to direct light into said section through said edge, thereby causing said light to be redirected by said lower surface through said slab toward said upper surface to illuminate said planar array of fluorescently labeled biological samples.

19. The method of claim 18 wherein step (b) comprises illuminating said slab through said edge in a non-uniform manner along the length of said edge to achieve an incident light intensity that increases toward each end of said edge.

20. The method of claim 18 further comprising filtering light from said light source prior to limit the light entering said slab to a preselected wavelength range.

21. The method of claim 18 further comprising collimating said light from said light source through a collimating lens between said light source and said edge.

22. The method of claim 18 wherein said edge is defined as an illuminated edge, and said lower surface is textured in a non-uniform manner along said surface to compensate for light loss through exposed edges of said slab adjacent to said illuminated edge.

23. The method of claim 18 further comprising increasing the brightness of light reaching said planar array of fluorescently labeled biological samples by passing said light through a brightness enhancement filter optically coupled to said upper surface.

24. The method of claim 18 wherein said within the range of a 1% wedge to a 10% wedge.

25. The method of claim 18 wherein said within the range of a 2% wedge to an 8% wedge.
